(19) United States
(12) Patent Application Publication
(10) Pub. No.: US 2018/0025291 A1
(43) Pub. Date: Jan. 25, 2018

(54) Data Processing System for Generating Data Structures

(71) Applicant: Carnegie Mellon University, Pittsburgh, PA (US)

(72) Inventors: Anind K. Dey, Pittsburgh, PA (US); Nikola Banovic, Pittsburgh, PA (US); Jennifer C. Mankoff, Pittsburgh, PA (US)

(21) Appl. No.: 15/655,666

(22) Filed: Jul. 20, 2017

Related U.S. Application Data
(60) Provisional application No. 62/493,896, filed on Jul. 20, 2016.
(60) Provisional application No. 62/493,894, filed on Jul. 20, 2016.

(51) Int. Cl. G06N 99/00; G06N 7/00

(52) U.S. Cl. CPC G06N 99/005; G06N 7/005

(57) ABSTRACT

A data processing system for structuring data includes a repository storing data referencing sources, the data representing actions and states for each of the sources. A data structuring engine generates a data sequence, for each source. Each data sequence represents states and actions for the source. An aggregation engine aggregates data sequences for the sources into a data structure, each entry of the data structure representing a state. Each entry includes an identifier for the state, a probability value of at least one action occurring at the state, the probability value based on a proportion of the data sequences comprising the state that also comprises the at least one action, and frequency data indicating a proportion of the data sequences included in the entry. A classification engine traverses the data structure and classifies the data sequences into groups based on probability values and frequency data associated with each state of each respective data sequence.

### CLAIM OF PRIORITY

This application claims priority under 35 U.S.C. §119(e) to U.S. patent application Ser. No. 62/493,896, filed on Jul. 20, 2016, and to U.S. patent application Ser. No. 62/493,894, file on Jul. 20, 2016, the entire contents of each of which are hereby incorporated by reference.

### GOVERNMENT RIGHTS

This invention was made with government support under CCF-1029549 and ITS-1217929 awarded by the National Science Foundation. The government has certain rights in the invention.

### BACKGROUND

Human routines are blueprints of behavior, which allow people to accomplish purposeful repetitive tasks at many levels, ranging from the structure of their day to how they drive through an intersection. People express routines through actions that they perform in the particular situations that triggered those actions. An ability to model routines and understand the situations in which they are likely to occur could allow technology to help people improve their bad habits, inexpert behavior, and other suboptimal routines. However, existing routine models do not capture the causal relationships between situations and actions that describe routines. Byproducts of an activity prediction algorithm can be used to model those causal relationships in routines.

Routine behavior defines the structure of and influences almost every aspect of people's lives. Routines include frequent actions people perform in different situations that are the cause of those actions. Routines include a type of purposeful behavior made up of goal-directed actions, which people acquire, learn and develop through repeated practice. As such, good routines enable predictable and efficient completion of frequent and repetitive tasks and activities. Routines can describe people's daily commute, their sleeping and exercising patterns, or even low-level tasks, such as how they operate their vehicle through an intersection. Routines, like most other kinds of human behaviors, are not fixed, but instead may vary and adapt based on feedback and preference. A key aspect of being able to understand and reason about routines is being able to model the causal relationships between people's situations and the actions that describe the routines. Routine variations are frequent departures from established routines, which are different from deviations and other uncharacteristic behavior that do not contribute to the routines. An ability to model routines and their variations, within and across people, could help researchers better understand routine behavior, and inform technology that influences routine behavior and helps people improve the quality of their lives.

Studies of routines often characterize routines in terms of a series of actions, typically derived from large activity data sets. Data mining algorithms automatically extract patterns from such data, while visualization can help researchers to interrogate the data. However, these existing approaches do not model the causal relationship between situations and actions. This makes it difficult to study and explain which situations or contexts, defined as the environmental information relevant to an individual's current activity, trigger which routine actions. A different approach is to detect, classify and predict activities from large data sets. Although such approaches imply the causality between the contexts and actions, it is difficult to extract meaning about routines from models learned using those algorithms and understand the reasons why they make certain classifications and predictions.

Many different stakeholders may care about understanding routine behavior. For example, a clear picture of the many aspects of routine behavior can help researchers to generate theories and models of human routine behavior. Designers may build on such theories to design technologies that help people to improve their routines. Models of human routines may be used for prediction and automation. Individuals may wish to reflect about their own routines for better understanding and supporting behavior change.

Although routine behaviors result from low-level cognitive plans, which can be modeled using existing cognitive architectures, such models are difficult to apply in understanding high-level routine behaviors. This document describes determining how routines are expressed in actions people perform in different contexts.

Visualizing data from behavior logs is a common way for researchers to identify routines. Logged behavior data is often visualized on a timeline as a sequence of events. The simplicity of this approach makes it applicable to a variety of domains, such as schedule planning to show uncertainty of duration of different events, visualizing family schedules, and representing events related to patient treatments. More advanced timelines enable the user to specify properties of the timeline for easier viewing. For example, Spiral Graph aligns sequential events on a spiral timeline using a user-defined period. However, due to the complexity and size of behavior logs, simply visualizing raw event data does not guarantee that the user will be able to find patterns of behaviors that form routines.

Other visualization approaches enable users to find patterns in time-series data by manually querying and highlighting different parts of behavior event sequences or manually aggregating common sequences of events based on features in the data until meaningful patterns emerge. The user is then able to judge the quality and saliency of the patterns by visual inspection. However, during the early exploratory stages, users might not always know what features are important and contribute to routine behavior patterns, making manual exploration challenging.

One major limitation of existing visualizations lies in their lack of support for both context and actions. Rather, they focus on isolated events, or temporal evolution of a particular state (e.g., sleep vs. awake) or variable (e.g., the amount of steps walked per day). Visualizing both context and actions is challenging partially because even advanced interactive visualizations have difficulty in visualizing routine patterns that depend on multiple heterogeneous variables, especially as the number of variables grows.

Automated routine extraction and summarization is another option for exploring routines in behavior logs. However, patterns extracted using the existing methods often do not include important aspects of routine behavior. For example, T-patterns can automatically find recurrences of events in behavior logs, but do not explicitly capture the contexts and actions. Other methods, such as Topic Models, include features that describe both context and actions, but without modeling the structure of possible variations from those routines. Methods based on Hierarchical Task Networks and Eigen decomposition capture the structural components of the contexts and actions, but do not explicitly model the causal relationship between the two that defines the routine. While these algorithms are helpful for extracting routine, they are not sufficient for helping to understand routine behaviors.

How people respond to routine variations is also an important part of routine behavior. Human routine behavior is not static, which makes variations from the routines inevitable. Variations often result from new contexts or unforeseen circumstances for which people have not yet found a routine, or occasions when people want to explore alternative ways to accomplish their tasks. For example, parents may vary their routine when their child has a new scheduled activity that is not part of their current routines or when they unexpectedly have to pick up their child from an existing activity.

Understanding variations is also important to understand the tradeoffs between different behaviors that people have. For example, in designing systems that help people comply with their gym routine, it is important to understand what other activities cause people to depart from their gym routine.

However, existing machine learning algorithms purposefully disregard variations in human behavior to focus on classifying and predicting only the most frequent human activity. Also, some variations may happen infrequently in data and are difficult to detect using those existing algorithms. Some specific infrequent variations may be detectable (such as detecting when parents are going to be late to pick up their children). However, this requires a case-by-case approach to address each kind of variation, which can be difficult to apply if all possible variations are not known a priori.

Furthermore, different people often develop their own routines to deal with their individual contexts. For example, differences in family daily routines can explain the responsibilities of different family members. To help people improve their routines, it is important to understand the difference between peoples' desired routines and their actual routines. For example, to design systems that help people better organize their schedules to avoid being late to pick up their children requires understanding differences between routines for days when they are late and days when they are on time.

Such comparisons can be performed between routines of an individual, but also between routines of different people or populations. For example, to create interventions that help aggressive drivers improve their driving style requires an understanding of the differences between aggressive and non-aggressive driving routines. Based on how closely these drivers are described by aggressive or non-aggressive routines, they can be classified into aggressive and non-aggressive groups. Researchers can then identify routine behaviors that need to change to make aggressive drivers less aggressive overall.

Existing algorithms can, of course, be applied to individual or population models of routines. For example, a standard strategy is to build a model for each population and then compare them to establish the differences and similarities between the populations. Population models can then be visualized using existing approaches: Hierarchical Task Networks can be visualized using existing Probabilistic Context-Free Grammar-based tools, and Arc Diagrams can visualize temporal patterns extracted using T-patterns. Those population models can then be coordinated and displayed across multiple views. However, such visualization techniques are not widely adopted. Finding differences in models is still often based on intuition and expert domain knowledge, and limited to visually comparing the distributions of feature values.

Manually exploring and labeling routine variations in a model to separate them from deviations is tedious. Without an ability to automatically detect and generate routine behavior instances, there are significant obstacles in developing technologies that help people improve their routines. For example, to alert drivers when their behavior is characteristic of an aggressive driving routine can require manually finding routine variations in the model that are characteristic of aggressive driving behavior. Similarly, showing the driver a non-aggressive alternative for the aggressive driving behavior above would require manually identifying an appropriate non-aggressive routine variation.

It is desirable to automatically detect which behavior instances are more characteristic of one routine (such as aggressive driving) than another (non-aggressive driving). However, there is no available technique that already satisfies this goal. Automated anomaly detection algorithms, which do not require any manual labeling, focus on deviations from some normal or expected behavior; i.e., they can be used to classify which behavior instances are not routine. However, they do not classify whether a behavior is a variation of one routine vs. another. Other unsupervised methods can cluster behavior instances, but they offer no guarantees that the behavior instance clusters they generate map onto routines.

The lack of individually labeled behavior instances makes it challenging to use existing supervised machine learning algorithms to classify behavior instances into routines. For example, Davidoff et al. trained a supervised machine learning algorithm to classify behavior instances that lead parents to forget to pick up their children. To do this, they had to manually label each behavior instance in the behavior logs they collected and confirm this information with the participants in their study. This places significant burden on developers to properly label enough data to be able to train their algorithms.

Such traditional machine learning methods may be used to generate behavior by predicting the action that the person is likely to perform in the current situation. This is because the labels for this task are implicit—the observed next action in the training behavior sequence offers ground truth of what the person actually did in the given situation. However, such methods may not be able to capture the complex sequences of situations and actions that make up routines. Also, the goal of those methods is to predict the most likely action in a given situation, which may hide the uncertainty and variance in human behavior.

Generative methods based on deep learning offer a way to capture more nuanced structures of routines. With enough labeled data, such methods can be trained to classify behavior instances, and even generate behavior using statistical sampling methods. However, unlike routine modeling approaches that have been shown to capture meaningful routines, the models trained using existing deep learning methods are difficult to inspect and understand by humans to ensure that they capture actual routine patterns in the data. Unfortunately, the existing routine models do not capture the probabilities that behavior instances belong to a routine model. This makes it challenging to detect and generate new behaviors using those routine models.

Unsupervised machine learning methods cluster behaviors without prior knowledge of labels. For example, algorithms based on Topic Models allow researchers to generate clusters of behavior instances. However, the main limitation of unsupervised methods is that they offer no guarantees that the resulting clusters group instances based on the routine they belong to (i.e., the clusters may not represent routines). Unsupervised anomaly detection algorithms could be used to find differences between behavior instances. However, they detect if a behavior instance is a deviation from a routine (i.e., behavior uncharacteristic of the routine), but not whether it is part of the routine.

Weakly labeled data approaches offer an efficient way to label data from large behavior logs. Such methods attempt to acquire error-prone but inexpensive labels, which introduces noise into the classification process. An example is to crowdsource labels, which works when the correct label is relatively clear to a naive observer. Another option is to weakly label data using “side information”—or information that implies the true label. To minimize the noise in the data, the side information needs to be determined in a principled way. For example, Reason et al. developed a standardized questionnaire that could classify people as aggressive or non-aggressive drivers. Such questionnaires could be used to label behavior instances of people based on their questionnaire responses.

### SUMMARY

This document describes a data processing system for structuring data. The data processing system includes a repository storing data referencing one or more sources, the data representing actions and states for each of the one or more sources. The data processing system includes a data structuring engine that generates a data sequence, for each source, from one or more portions of the stored data for that source, each data sequence representing one or more states and one or more actions for the source. The data processing system includes an aggregation engine that aggregates data sequences for the one or more sources into a data structure, each entry of the data structure representing a state, each entry including an identifier for the state; a probability value of at least one action occurring at the state, the probability value based on a proportion of the data sequences, including the state, that also comprise the at least one action; and frequency data indicating a proportion of the data sequences included in the entry. The data processing system includes a classification engine that traverses the data structure and classifies the data sequences into groups based on probability values and frequency data associated with each state of each respective data sequence.

In some implementations, the classification engine identifies a first data sequence of a group of data sequences to be a particular sequence, and a second data sequence of the group to be a variation of the particular sequence, the variation including at least one particular action for a data sequence having a probability value above a predetermined threshold. In some implementations, the data processing system includes a simulation engine for generating, using the data structure, a simulation.

In some implementations, the simulation includes an environment having one or more objects and one or more data sequences automatically generated by the simulation engine, each data sequence of the one or more data sequences representing behavior of an object of the one or more objects of the environment. The one or more data sequences are automatically generated by selecting, from the data structure generated, a group of the data sequences classified by the classification engine; retrieving, from the data structure generated, probability values associated with states of the data sequences of the group; retrieving, from the data structure generated, frequency data associated with the states of the data sequences of the group; and generating a data sequence that simulates a new source by traversing the data structure according to the probability values and the frequency data. In some implementations, the one or more objects behave in the simulation according to the generated data sequence representing the behavior of the object.

In some implementations, the simulation includes an interface including one or more controls for controlling behavior of an additional object and a display for the environment of the simulation, and a logging engine that records the behavior of the additional object. In some implementations, the data structuring engine generates an additional data sequence for the additional object according to the behavior of the additional object recorded by the logging engine. In some implementations, the classification engine classifies the additional data sequence into one of the groups. In some implementations, the aggregation engine updates the probability values and the frequency data based on the additional data sequence.

In some implementations, each state comprises a feature vector representing one or more characteristics of the state. In some implementations, each state is associated with a utility score based on one or more probability values and frequency data associated with the state.

In some implementations, the data processing system includes a visualization engine that generates a visual representation of a group of data sequences. In some implementations, the visual representation includes an indicator for each of the states and actions of the data sequences of the group; a representation of each probability value; and an indication of a particular data sequence of the group. In some implementations, the visual representation comprises one or more selectable controls for selecting a data sequence of the group. In some implementations, the visual representation provides a visual indication of a variation of the selected data sequence, the variation including at least one particular action for a data sequence based on a probability value of the particular action.

In some implementations, the data structuring engine extracts the actions and the states from the data referencing one or more sources by identifying one or more features of the data that correspond to a state or an action. In some implementations, the data representing one or more sources comprises behavior logs.

In some implementations, visualization includes a first and second display. In some implementations, the first display includes a first data sequence of a data structure, the first data sequence representing first states and first actions. In some implementations, the first states and the first actions are ordered and each displayed proximate to respective one or more representations of one or more feature vectors that define the first states and the first actions; one or more second data sequences, the one or more second data sequences representing second states and second actions that are less likely to occur relative to occurrences of the first states and the first actions of the first data sequence; and one or more connectors that connect the first states and the first actions to one another and to the second states and the second actions, where a thickness a connector represents a probability value. In some implementations, each of the first states, the first actions, the second states and the second actions comprise a selectable control that enable the first display to show additional states and additional actions when the selectable control is activated, and where each of the first states, the first actions, the second states, and the second actions each comprise a passive control, where the passive control enables the first display to show additional details about a respective state or action when the passive control is activated; and a second display rendering a visual representation of the data structure.

A method for structuring data includes storing data referencing one or more sources, the data representing actions and states for each of the one or more sources; generating a data sequence, for each source, from one or more portions of the stored data for that source, each data sequence representing one or more states and one or more actions for the source; aggregating data sequences for the one or more sources into a data structure, each entry of the data structure representing a state, each entry including: an identifier for the state; a probability value of at least one action occurring at the state, the probability value based on a proportion of the data sequences, including the state, that also comprise the at least one action; and frequency data indicating a proportion of the data sequences included in the entry; and traversing the data structure to classify the data sequences into groups based on probability values and frequency data associated with each state of each respective data sequence.

In some implementations, the actions include identifying a first data sequence of a group of data sequences to be a particular sequence, and a second data sequence of the group to be a variation of the particular sequence, the variation including at least one particular action for a data sequence having a probability value above a predetermined threshold.

In some implementations, the actions include simulating an environment having one or more objects; and automatically generating one or more data sequences, each data sequence of the one or more data sequences representing behavior of an object of the one or more objects of the environment, the one or more data sequences being automatically generated by: selecting, from the data structure generated, a group of the data sequences classified; retrieving, from the data structure generated, probability values associated with states of the data sequences of the group; retrieving, from the data structure generated, frequency data associated with the states of the data sequences of the group; and generating a data sequence that simulates a new source by traversing the data structure according to the probability values and the frequency data; where the one or more objects behave in the simulation according to the generated data sequence representing the behavior of the object.

In some implementations, the actions include receiving commands from an interface including one or more controls for controlling behavior of an additional object; displaying the behavior of the additional object; recording the behavior of the additional object; generating an additional data sequence for the additional object according to the behavior of the additional object; and classifying the additional data sequence into one of the groups.

In some implementations, the actions include updating the probability values and the frequency data based on the additional data sequence. Each state comprises a feature vector representing one or more characteristics of the state. Each state is associated with a utility score based on one or more probability values and frequency data associated with the state.

In some implementations, the actions include generating a visual representation of a group of data sequences, where the visual representation comprises: an indicator for each of the states and actions of the data sequences of the group; a representation of each probability value; and an indication of a particular data sequence of the group. The visual representation comprises one or more selectable controls for selecting a data sequence of the group. The visual representation provides a visual indication of a variation of the selected data sequence, the variation including at least one particular action for a data sequence based on a probability value of the particular action.

This document describes a data processing system for automatically extracting and modeling routines and routine variations from human behavior logs. The system described herein supports both individual and population models of routines, providing the ability to identify the differences in routine behavior across different people and populations. The byproducts of MaxCausalEnt, a decision-theoretic algorithm typically used to predict activity of people, encode the causal relationship between routine actions and context in which people perform those actions. These causal relationships allow for reasoning about and understanding of the extracted routines.

Using two different existing human activity data sets, the data processing system extracts different types of routines from diverse types of behavior: people's daily schedules and commutes and activities that describe how people operate a vehicle. The extracted routine patterns are at least as predictive of behaviors in the two behavior logs as the baseline we establish with existing algorithms. The data processing system includes a user interface that enables users to verify that patterns extracted are meaningful and match the ground truth reported in previous work. The user interface enables the researchers to visually explore and compare the extracted routines.

The data processing system enables extraction of a reasonable set of human readable patterns of routine behavior from behavior logs. The data processing system produces models of causal relationships that can help researchers explore, understand, and form new insights about human routines from behavior logs without having to manually search for those patterns in raw data. The data processing system enables efficient automated prediction and reasoning about routines even under uncertainty that is inherent in human behavior.

In some implementations, the knowledge that the researchers gain about routine behaviors through exploring the visualization tool can inform the design of interventions that help people improve their routines. For example, the knowledge that aggressive drivers are likely to use higher throttles can inform the design of in-car systems that monitor the throttle and make the driver more aware of this aggressive behavior through subtle ambient notifications. Another advantage of our approach is the underlying MDP-based model, which can be used to power smart agents that automatically classify current behaviors and prescribe new actions that improve existing routines.

The data processing system described herein includes an ability to detect behaviors that negatively impact people's wellbeing and show people how they can correct those behaviors could enable technology that improves people's lives. The data processing system analyses a domain of routine behaviors and models routines as a series of frequent actions that people perform in specific situations. The data processing system bypasses labeling each behavior instance that a person exhibits, and instead weakly labels instances using people's demonstrated routine. The data processing system classifies and generates new routine instances based on the probability that the routine instances belong to the routine model. An example system is shown that helps drivers become aware of and understand their aggressive driving behaviors. The data processing system enables technology that can trigger interventions and help people reflect on their behaviors when those behaviors are likely to negatively impact them.

The details of one or more embodiments are set forth in the accompanying drawings and the description below. Other features, objects, and advantages of the invention will be apparent from the description and drawings, and from the claims.

### DESCRIPTION OF DRAWINGS

FIG. 1 shows an overview of a data processing system.

FIG. 2 shows an example of a visualization.

FIG. 3 shows an example of a simulation interface.

FIG. 4 shows an example computing system.

Like reference symbols in the various drawings indicate like elements.

### DETAILED DESCRIPTION

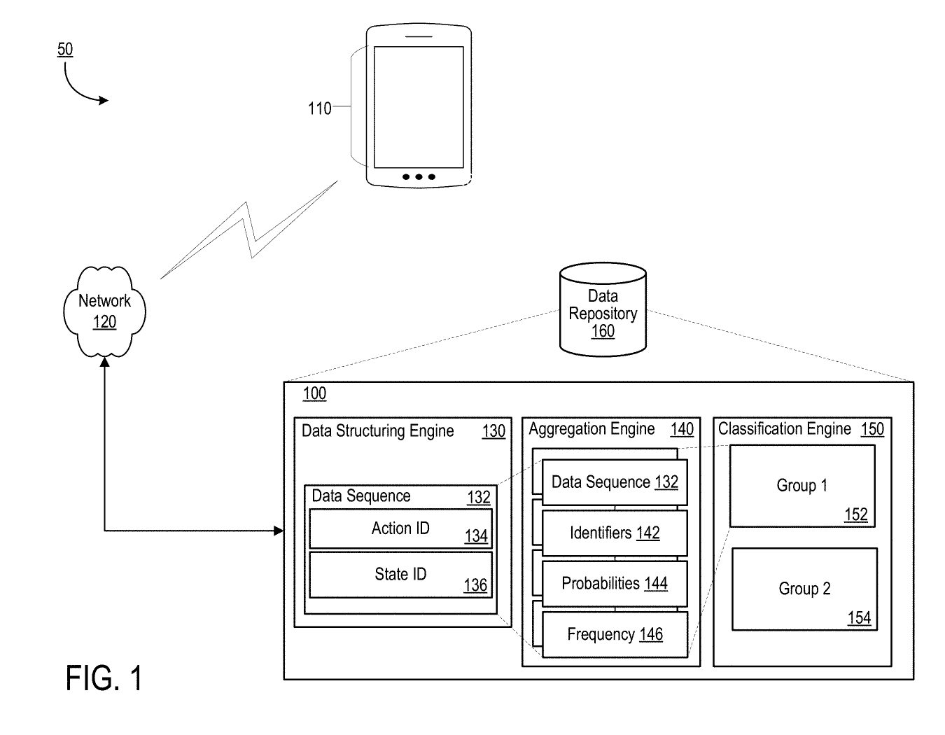

FIG. 1 shows a networked environment 50 including an example data processing system 100 for modeling human routine behavior. The data processing system 100 applies an existing decision-theoretic algorithm to the domain of routine modeling. To identify routine patterns (RQPat), the data processing system 100 explicitly models the causal relationship between contexts in which different routines occur and the actions that people perform in those contexts. Unlike models that extract only the most frequent routines, the data processing system 100 also models possible variations from those routines (RQVar), even in infrequent contexts. The data processing system 100 does this by modeling probability distributions over different possible behaviors, which allows the researcher to make sense about which of those behaviors form routines and which form variations. The data processing system 100 models both individual and population routine behavior, and thus allows comparisons between those models (RQComp).

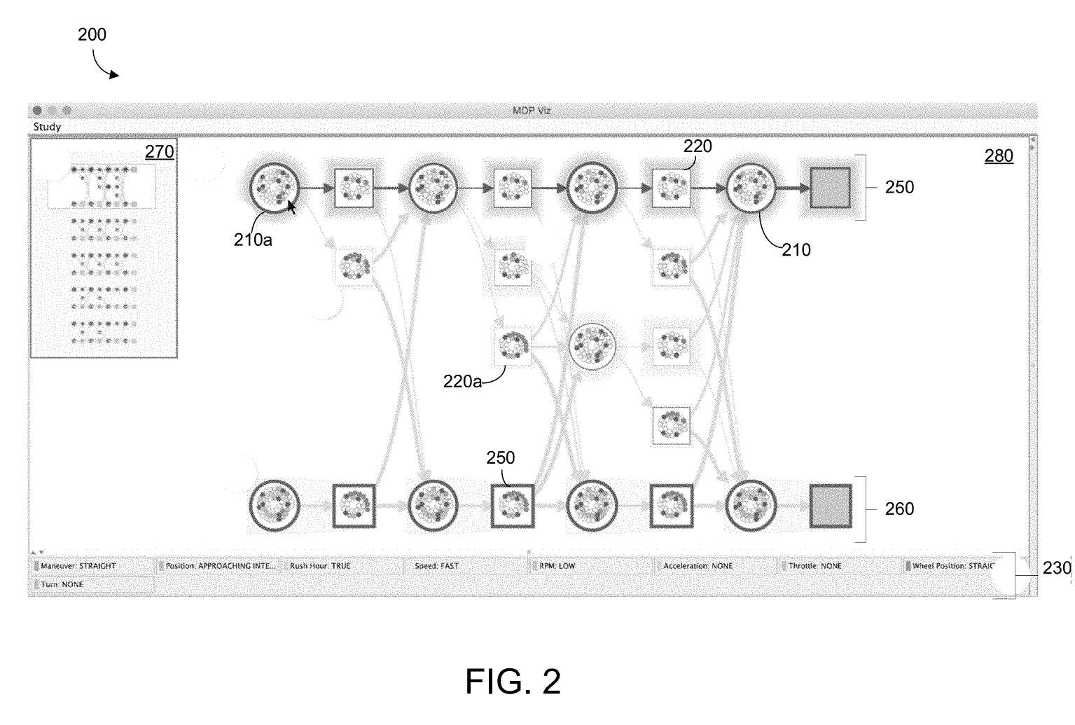

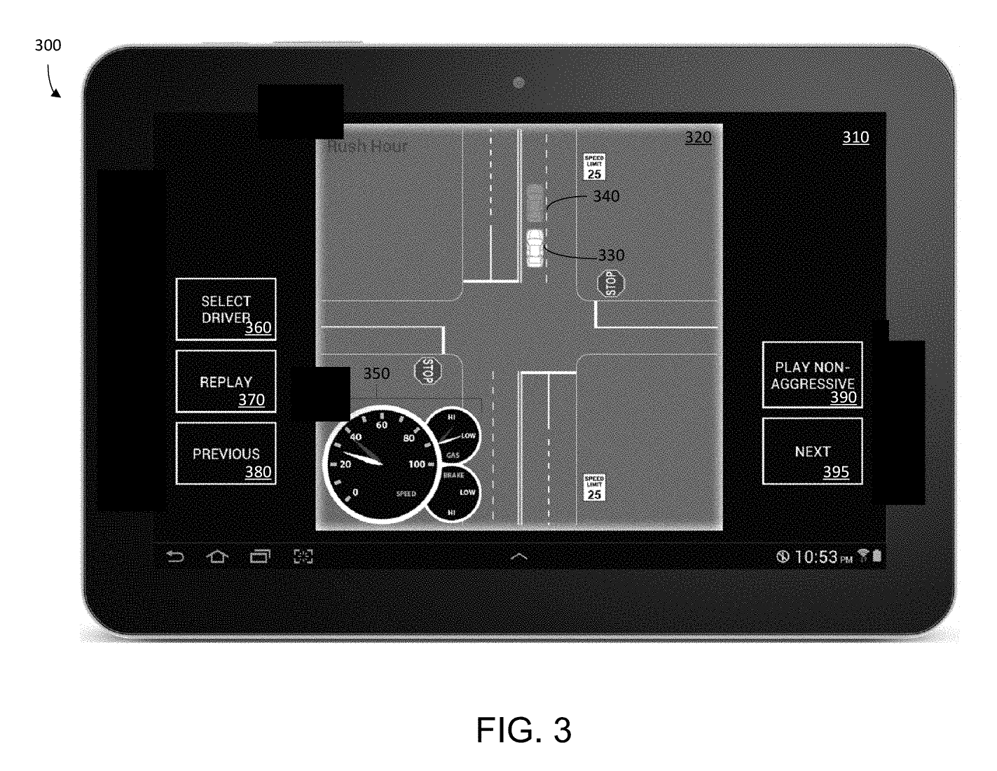

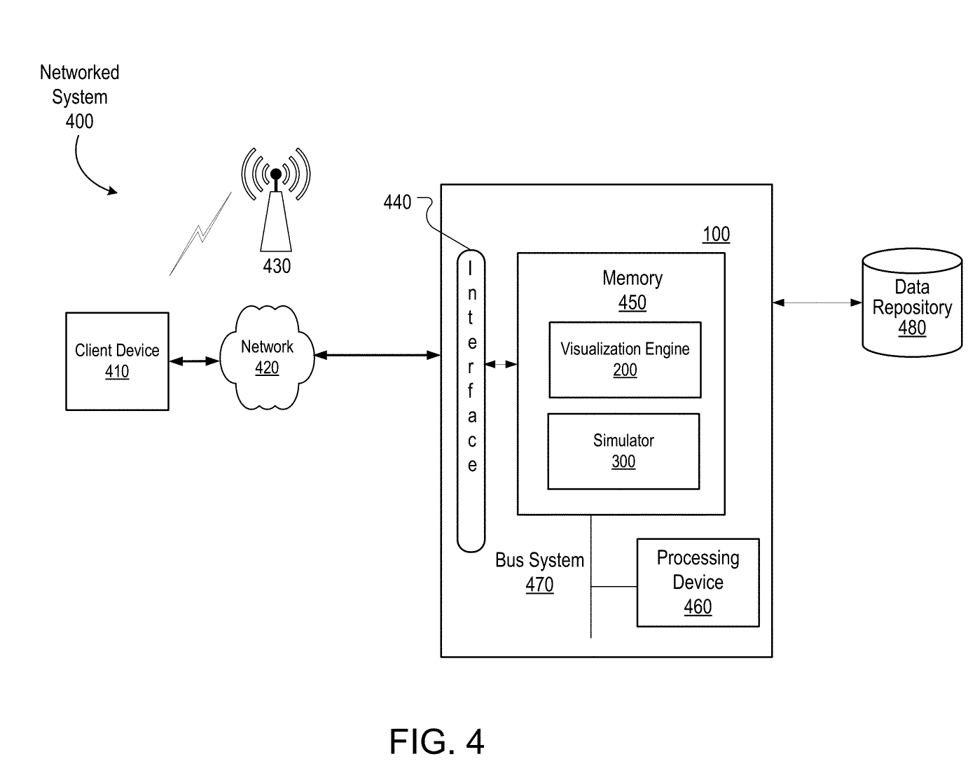

The networked environment includes a client device 110 and a network 120, described below in greater detail with respect to FIG. 4. The data processing system 100 includes a data structuring engine 130, an aggregation engine 140, and a classification engine 150. The data structuring engine generates data sequences 132 from data in a data repository 160, as described in further detail below. The data sequence 132 includes actions represented by action identifiers 134 and states represented by state identifiers 136. For one or more applications, such as for visualization and simulation described in relation to FIGS. 2 and 3, respectively, the data sequences 132 are aggregated into a data structure by aggregation engine 140.

The aggregation engine 140 generates a data structure for using the data sequences in applications of simulation and visualization. The aggregation engine 140 generates a data structure with a number of entries, each entry comprising one or more states or actions of a data sequence, such as data sequence 132. The entries also store identifiers 142 for the states and actions of the data sequence 132, probability values 144 representing a likelihood that the state or action is a part of a routine sequence, and frequency data 146 that represents how frequently the state or action is a part of a sequence.

A classification engine 150 groups the data sequences, such as data sequence 132, into groups, such as groups 152 and 154. The groups represent which sequences are parts of routines (or variations thereof) that represent a characteristic type of behavior. For example, group 152 can represent aggressive driving routines, while group 154 can represent non-aggressive driving routines. While two groups are represented, the classification engine 150 can classify the sequences into any number of groups as appropriate.

In some implementations, if a sequence has one or more states or actions over a given probability value threshold, the one or more states and actions can be determined by the data processing system 100 to be a part of a routine sequence, displayed as a primary or main sequence in a visualization (as described in relation to FIG. 2).

The data processing system 100 can communicate with a data repository 160. In some implementations, the data processing system 100 includes the data repository 160.

Human behavior data is often collected using different sensors and stored into behavior logs. The data processing system 100 converts the behavior logs into sequences of events representing people's current context and the actions they perform in that context. The data processing system 100 uses those sequences of events to model human routine behavior.

The data processing system 100 models demonstrated routine behavior using a Markov Decision Processes (MDP) framework. MDP is particularly well suited for modeling human routine behavior because it explicitly models the user's context, the actions that can be performed in that context, and the preferences people have for different actions in different contexts. A Markov decision process is a tuple:

[symbol]

_{MDP}=(S,A,P(s′|s,a),R(s,a))

The tuple consists of a set S (s E S) of states representing context, and actions A (a ∈ A) that a person can take. In addition, the model includes an action-dependent probability distribution for each state transition P(s′|s, a), which specifies the probability of the next state s′ when the person performs action a in states. This state transition probability distribution P(s′|s, a) models how the environment responds to the actions that people perform in different states. When modeling human behavior, the transitions are often stochastic (each pair (s, a) can transition to many transition states s′ with different probabilities). However, if the person has full control over the environment, they can also be deterministic (i.e., for each pair (s, a) there is exactly one transition state s′ with probability 1). Finally, there is a reward function R(s, a)→ [symbol] that the person incurs when performing action a in state s, which represents the utility that people get from performing different actions in different contexts.

People's behavior is then defined by sequences of actions they perform as they go from state to state until reaching some goal state. In an MDP framework, such behavior is defined by a deterministic policy (π: S→A), which specifies actions people take in different states. Traditionally, the MDP is “solved” using algorithms, such as value iteration, to find an optimal policy (with the highest expected cumulative reward). However, our goal is to find the expected frequencies of different states and the probability distribution of actions given states (P (a|s)) instead—information necessary to identify people's routines and variations.

The data processing system 100 uses the MaxCausalEnt algorithm to extract routine behavior patterns from observed data. The MaxCausalEnt algorithm makes its predictions by computing a policy (π: S→A) that best predicts the action people take in different states. In the process of computing this policy, the MaxCausalEnt algorithm computes two other functions that express how likely it is that a state and action are part of a routine. The first function is the expected frequency of states (Dₛ). The second function is a probability distribution of actions given states (P (a|s)). The data processing system 100 computes these two functions to identify and characterize routines.

The data processing system 100 uses Inverse Reinforcement Learning (IRL) approaches, on which MaxCausalEnt is based, and which assigns a utility function (modeled as the reward functions R (s, a)), to model which action people will perform in different demonstrated states. Each state and action combination in our MDP model is expressed by a feature vector F_{S,A}. For example, in an MDP that models daily commute routines, states can have features that describe possible locations that a person can be at, and actions can have features that describe if the person is staying at or leaving the current location. The data processing system 100 uses a parametric reward function that is linear in F_{S,A}, given unknown weight parameters θ:

R(s,a)=θ^{t}

[symbol]

The data processing system 100 recovers the expected state frequencies (Dₛ) and probability distribution of actions given states (P (a|s)) by learning a person's reward functions R (s, a) from demonstrated behavior. This problem reduces to matching the model feature function expectations (E_{P(sa,)}[ [symbol] (S,A)]) with demonstrated feature expectations (E_{P(S,A)}[ [symbol] (S,A)]). To match the expected counts of different features, the data processing system 100 uses MaxCausalEnt IRL, which learns the parameters of the MDP model to match the actual behavior of the person. Unlike other approaches described earlier, the data processing system 100, using the MaxCausalEnt algorithm, explicitly models the causal relationships between context and actions, and keeps track of the probability distribution of different actions that people can perform in those contexts.

To compute the unknown parameters θ, the data processing system 100, using the MaxCausalEnt algorithm, considers the causal relationships between the different features of the states and the actions. The Markovian property of MDP, which assumes that the actions a person performs only depend on the information encoded by the previous state, makes computing the causal relationships between the states and actions computationally feasible. The data processing system 100, using the MaxCausalEnt algorithm, extends the Principle of Maximum Entropy to cases where information about probability distribution is sequentially revealed, as is the case with behavior logs. This principle ensures that the estimated probability distribution of actions given states (P (a|s)) is the one that best fits the state and action combinations from the sequences in the behavior logs.

The data processing system 100, by using the MaxCausalEnt IRL algorithm, maximizes the causal entropy (H(A^{T}|S^{T})) of the probability distribution of actions given states (P(Aₜ|Sₜ)):

$${argmax}_{p ( {A}_{t} \vert {S}_{t} )} H ( {A}^{T} \vert \vert {S}^{T} )$$

such that:

E_{P(S,A)} [symbol] (S,A)]=E_{P(S,A)}[ [symbol] (S,A)]

∀_{S}_{_{t,}}_{A}_{ₜ}P(Aₜ|Sₜ)≧0

∀_{S}_{_{t,}}_{A}_{ₜ}ΣP(Aₜ|Sₜ)=1

The first constraint in the above equation ensures that the feature counts calculated using the estimated probability distribution of actions given states (P (Aₜ|Sₜ)) matches the observed counts of features in the data, and the other two ensure that (P (Aₜ|Sₜ)) is an actual probability distribution.

Using the action-based cost-to-go (Q), which represents the expected value of performing action aₜ in state sₜ, and state-based value (V) notation, which represents the expected value of being in state sₜ, the procedure for MDP MaxCausalEnt IRL reduces to:

$${Q}_{θ}^{soft} ( {a}_{t} , {s}_{t} ) = {\sum }_{{s}_{t + 1}} P ( {s}_{t + 1} \vert {s}_{t} , {a}_{t} ) \cdot {V}_{θ}^{soft} ( {s}_{t + 1} ) \\ {V}_{θ}^{soft} ( {s}_{t} ) = {softmax}_{{a}_{t}} {Q}_{θ}^{soft} ( {a}_{t} , {s}_{t} ) + {θ}^{T} \cdot {ℱ}_{{s}_{t} , {a}_{t}} \qquad ( 4 )$$

This is similar, but not the same as stochastic value iteration, which would model optimal and not observed behavior. The probability distribution of actions given the states is then given by:

$$P ( {a}_{t} \vert {s}_{t} ) = {e}^{{Q}_{θ}^{soft} ( {a}_{t} , {s}_{t} ) - {v}_{θ}^{soft} ( {s}_{t} )}$$

The probability distribution of actions given states (P (a|s)) and the state transition probability distribution (P(s′|s, a)) are used in a forward pass to calculate the expected state frequencies (Dₛ). The data processing system 100 solves this optimization problem using a gradient ascent algorithm. Ziebart provides proofs of these claims and detailed pseudocode for the algorithm above.

The data processing system 100 was tested using two previously collected data sets from the literature that include logs of demonstrated human behavior. The first data set includes daily commute routines of family members from three two-parent families with children from a mid-sized city in North America. The data set was used to predict the times the parents are likely to forget to pick up their children. The other data set includes driving routine behavior of aggressive and non-aggressive drivers as they drive on their daily routes. The data processing system 100 used the second data set to classify aggressive and non-aggressive drivers.

The two data sets include routine tasks people perform on a daily basis, but that are very different in nature. The family daily routine data set incorporates the traditional spatio-temporal aspect of routines most of the existing work focuses on. The driving data set includes situational routines that are driven by other types of context (e.g., the surrounding traffic, the current position of the car in the intersection).

The two data sets also differ in granularity of the tasks. The commute routines happen over a longer period of time and the granularity of the task is very coarse with few actions that people can perform in different contexts (e.g., stay at the current place or leave and go to another place). The daily routines are therefore defined by the states the people are in. The aggressive driving data set includes data specifying fine-grained actions, which often occur in parallel, that people perform to control the vehicle (e.g., control the gas and brake pedals and the steering wheel). Driving routines are therefore primarily defined by the drivers' actions in different driving situations. The driving data set also showcases the ability of the data processing system 100 to capture population models (e.g., aggressive drivers vs. non-aggressive drivers) and enable comparison of routines across different populations.

The data in the two example data sets consists of sequences of sensor readings, which the data processing system 100 converted into sequences of events represented by state action pairs. Parsing the raw data, the data processing system 100 extracts: 1) a set of states S defined by a set of features [symbol] ₜ which represent context, 2) a set of actions A defined by a list of binary features [symbol] ₜ which represent activities that the people can perform, and 3) empirically estimated state-action transition dynamics (P(s′|s, a)). At any discrete event step, the state features includes values of the contextual sensor readings at that event, and actions include feature values describing the activity the people performed at that event. The data processing system 100 estimates state-action transition dynamics based on the frequencies of state transitions in the state-action event sequences and estimate the expected state frequency counts (Dₛ) and the state-action probability distributions (P (a|s)) as described in the previous section.

Situations when one of the parents is unable to pick up or drop-off a child create stress for both parents and children. To better understand the circumstances under which these situations arise, it is important to identify when the parents are responsible for picking up and dropping off their children (RQPat), when variations from normal routines occur and how parents handle those situations (RQVar). This requires finding and understanding how the parents organize their daily routines around those pickups and drop-offs (RQComp).

This data includes location sampling (latitude and longitude) at one-minute intervals for every family member (including children) in three families from a mid-sized city in North America. Location information was manually labeled based on information from bi-weekly interviews with participants. Participants also provided information about their actual daily routines during those interviews.

The data processing system 100 converted the location logs into sequences of states and actions representing each individual's daily commute for each day in the data set. State features included the day of the week, hour of the day, participant's current place, and whether the participant stayed at the location from the previous hour, arrived at the location during the current hour, or left the location during the hour (Table 1). Action features included the participant's current activity that could be performed in those states (Table 2). Participants could stay for another hour, leave the location, and once they have left a location go to another location. The data included a total of 149 days.

The data processing system 100 models the state transition probabilities (P (s′|s, a)) as a stochastic MDP to model the environment's influence on arrival time to a destination. The participants could stay or leave a place with 100% probability. Once the participants leave their current location, their arrival time at their destination depends on their desired arrival time and the environment (e.g., traffic, travel distance). To model the influence of the external variables, the data processing system 100 empirically estimates the probability that participants have arrived at another place within an hour or not. The median number of states and actions per family were 14,113 and 85 respectively, for combinations of possible features.

TABLE 1
State features capturing the different contexts of a daily commute.

| Feature | Description |
|---|---|
| Day | Day of week {M, T, W, Th, F, Sa, Su} |
| Time | Time of day in increments of 1 hour {0-23} |
| Location | Current location |
| Activity | Activity in the past hour |
| | {STAYED AT, ARRIVED AT, TRAVELING FROM} |

TABLE 2
Action features representing actions that
people can perform when at a location.

| Feature | Description |
|---|---|
| Activity | Activity people can perform in current context |
| | (STAY AT, TRAVEL TO} |
| Location | The current location to stay at or next location to go to |

To understand and extract aggressive driving routines, the data processing system 100 explores the types of contexts aggressive drivers are likely to prefer (e.g., turn types, car speed, acceleration) and the driving actions they apply in those contexts (e.g., throttle and braking level, turning) (RQPat). Aggressive drivers might also be prone to dangerous driving behavior that does not occur frequently (e.g., rushing to clear intersections during rush hour). Such behavior might manifest itself as variations from established routines (RQVar).

The data processing system 100 compares the routines of aggressive drivers with non-aggressive drivers to understand how aggressive drivers can improve their routine (RQComp). To understand those differences, it is not enough to compare the contexts both groups of drivers find themselves in, but also the actions that drivers perform in those contexts. This is because both aggressive and non-aggressive drivers can attain similar driving contexts, but the quality of the execution of driving actions may differ. For example, both types of drivers might stop at a stop sign on time, but aggressive drivers might have to brake harder or make more other unsafe maneuvers than non-aggressive drivers.

This data set includes driving data from 22 licensed drivers (11 male and 11 female; ages between 21 and 34) from a mid-sized city in North America. Participants were asked to drive their own cars on their usual daily driving routes over a period of 3 weeks. Their cars were instrumented with a sensing platform consisting of an Android-based smartphone, On-board Diagnostic tool (OBD2), and an inertial measurement unit (IMU) mounted to the steering wheel of the car. Ground truth about participants' driving styles (aggressive vs. non-aggressive) was established using their self-reported driving violations and responses to the driver behavior questionnaire. The driving data collected in the study included: car location traces (latitude and longitude), speed, acceleration, engine RPM, throttle position, and steering wheel rotation. Sensor data was recorded every 500 milliseconds.

The data processing system 100 uses a subset of this data focused on intersections (where instances of aggressive driving are likely to occur). The data processing system 100 used location traces of the participants' driving routines to label intersections and the position of the vehicle in those intersections. One of the limitations of this data set is that there is no information about other vehicles and traffic signs and signals that represent the environment. The data processing system 100 then splits the intersection instances into sequences of sensor readings that start 2 seconds before the car enters the intersection, and end 2 seconds after the car exits the intersection. This resulted in a total of 49,690 intersections from a total of 542 hours of driving data from 1,017 trips.

To model states the data processing system 100 combined the driver's goals (e.g., make a right turn), the environment (e.g., position in intersection), and the current state of the vehicle (e.g., current speed) into features of the states (Table 3, below). Actions in the model represent how the driver operates the vehicle by steering the wheel, and depressing the gas (throttle) and brake pedals. The data processing system 100 aggregates the driver's actions between different stages of the intersection and represent the median throttle and braking level, and identifies any spikes in both throttle and braking. The data processing system 100 considers the movement of the steering wheel to estimate whether the driver turned in one smooth action, or if the turn required one or more adjustments.

TABLE 3
State features capturing the different contexts the driver can be in.

| | |
|---|---|
| Feature | Description |

Goals

| | |
|---|---|
| Maneuver | The type of maneuver at the intersection |
| | {STRAIGHT, RIGHT TURN, LEFT TURN, U-TURN} |

Environment

| | |
|---|---|
| Position | Current position of the car in the intersection |
| | {APPROACHING, ENTERING, EXITING, AFTER} |
| Rush hour | Whether the trip is during rush hour or not |
| | {TRUE, FALSE} |

Vehicle

| | |
|---|---|
| Speed | Current speed of the vehicle (5-bin discretized) |
| Throttle | Current throttle position (5-bin discretized) |
| Acceleration | Current positive/negative acceleration (9-bin discretized) |
| Wheel Position | Current steering wheel position |
| | {STRAIGHT, TURNING, RETURNING} |
| Turn | Current turn vehicle is involved in |
| | {STRAIGHT, SMOOTH, ADJUSTED} |

Table 4 shows action features in our model. The data processing system 100 identified 7,272 different states and 446 different actions in the data set.

TABLE 4
Action features representing actions that drivers can
perform between stages of the intersection.

| Feature | Description |
|---|---|
| Pedal | Median throttle (gas and brake pedal) position |
| | (10-bin discretized) |
| Throttle Spike | Sudden increases in throttle |
| | {NONE, SUDDEN, INTERMITTENT} |
| Brake Spike | Sudden braking |
| | {NONE, SUDDEN, INTERMITTENT} |
| Turn style | Type of turn driver performed in intersection |
| | {STRAIGHT, SMOOTH, ADJUSTED} |

The data processing system 100 evaluates the quality of the routines extracted using its model from the two data sets. First, the routine actions extracted are predictive of the majority of behaviors in the data; i.e., that the algorithm is sufficiently predictive for modeling routines. Accuracy of this prediction task also quantifies the variability of the routines in the model, where high accuracy suggests low variability. It also shows that the extracted routines generalize to contexts and actions that we have not observed during model training. Second, the routines extracted using the data processing system 100 are meaningful. The patterns extracted using the data processing system 100 correspond to the actual routines and routine variations in our two example behavior logs (RQPat & RQVar). The extracted routines and variations show the real differences between modeled populations (RQComp).

The task of predicting the next action given a state to is used evaluate the data processing system 100 ability to extract routines. Using 10-fold cross validation for each person in each dataset, the performance of this algorithm for extracting routine behavior was compared with a simple Zero-R algorithm, which always predicts the overall most frequent action, and a first-order Markov Model algorithm, which always predicts the most frequent action for each state. These two baselines explicitly establish the frequency of actions in the training set. Matching or exceeding these baselines means that the algorithm has correctly identified frequent routine actions and that the predictive power of the algorithm is sufficiently high to model routines.

The mean accuracy of the MaxCausalEnt on the family daily routines dataset was 0.81 (SD=0.09), compared to first-order Markov Model mean accuracy of 0.66 (SD=0.07) and ZeroR mean accuracy of 0.51 (SD=0.09). The data processing system 100 using the MaxCausalEnt algorithm likely outperformed the first-order Markov Model of prior systems because of its ability to better generalize from training data. The accuracy of the data processing system 100 using the MaxCausalEnt algorithm also suggests low variability of routines in people's daily schedules.

The mean accuracy of the MaxCausalEnt on individual models of driving routines was 0.54 (SD=0.05) compared to first-order Markov Model mean accuracy of 0.58 (SD=0.06) and ZeroR mean accuracy of 0.33 (SD=0.06). The data processing system 100 using the MaxCausalEnt algorithm and the first-order Markov Model had similar accuracies likely because in each fold the training set was representative of the testing set. However, decision-theoretic guarantees of the data processing system 100 using the MaxCausalEnt algorithm ensures that it makes the least number of assumptions to fit the observed data make it less likely to over-fit the training data in general. Relatively low accuracy of both the MaxCausalEnt algorithm and the first-order Markov Model on this data set suggests that there is a lot of variability in the driving routines.

The routine patterns extracted using the data processing system 100 match the actual routines of people. Researchers that work with machine learning and data mining in the domain of human behavior, were asked to identify the routines and variations extracted using the data processing system 100. It was confirmed that those patterns matched the ground truth behaviors established in the previous work. It was verified that the patterns extracted using our approach are meaningful and represent the actual routines.

FIG. 2 shows a visualization tool 200. The visualization tool 200 makes the routine behavior models created using the data processing system 100 accessible to participants and allows them to investigate the extracted routine patterns. To maintain a level of familiarity, the visual encoding of routine behavior elements is based on a visual representation of an MDP as a graph. The visualization tool 200 MDP graph includes nodes 210 representing states (as circles) and actions 220 (as squares), directed edges from state nodes to action nodes (indicating possible actions people can perform in those states), and directed edges from actions to states (indicating state transitions for any given state and action combination).

The visualization tool 200 includes state features and action features as a series of color-coded circular marks arranged in a spiral shape within the nodes, to enable participants to see changes in features of states and actions. Each feature has a dedicated hue. Feature values that are present in the node are represented by a dark shade, and feature values not present in a light shade of that color. A dark boundary serves as a separator between features. More details 230 in text are available, and can be activated when a cursor is moved over a node.

The visualization tool 200 shows frequent behaviors in the model. The visualization tool 200 represents the probability of different graph elements using lines (e.g., lines 240) and differing line thickness. Thickness of the edges (e.g., edge 250) of the state and action nodes encodes the frequency of that state in a behavior sequence (Dₛ), where thicker lines indicate states that are likely to be part of a routine. Similarly, the thickness of the edges encodes the probability of that edge. Thickness of edges from states to actions is given by the probability distribution of actions given states (P (a|s)), and represents the influence of each state on the choice of actions. The thickness of edges from actions to states is given by the probability of transition (P(s′|s, a)).

To layout the nodes, the visualization tool 200 sorts the initial states from the demonstrated sequences by their frequency (Dₛ) in descending order. The visualization tool 200 uses a version of the depth-first search algorithm, starting from the initial state nodes, that traverses nodes by first iterating over edges in order from highest to lowest probabilities (P (a|s)) and (P(s′|s, a)). State nodes are never duplicated (i.e., there is exactly one node in the layout for each state in the model), whereas action nodes are duplicated for each state.

The visualization tool 200 shows the main routine 250 and one likely variation 260 of non-aggressive drivers extracted using our approach. The visualization tool 200 includes an overview panel 270 and a main display area 280 including subgraphs representing automatically extracted routine sequences of states 210 (circles) and actions 220 (squares). At state 210a, a user is hovering over a node to highlight extracted routine (nodes highlighted in dark edges). An action 220a that starts a variation from the main routine is shown. The visualization tool 200 includes aggregate items representing possible extracted variations, such as actions 220a and 220b. The visualization tool 200 includes a details panel 230 showing information about visual elements on demand.

When a user selects a data set and population, the visualization tool 200 provides the initial layout of routines extracted using the data processing system 100. This shows the most important information about the extracted routines. However, to further analyze the routine behavior, the participant must be able to explore the details of routine variations filtered out as aggregate nodes, such as in variation 260. For example, the participant might want to find which of the parents' routines include locations where they pick up and drop off their children.

Aggregated items can include valuable information about potential routine variations. For example, a child might go to her grandparents or their friend's house on Wednesdays after school; two variations on the same routine that occur with similar probability. To show possible variations in an aggregate in the visualization tool 200, the user can click on the aggregate to expand its content. To mark an aggregated node as a variation of interest in the visualization tool 200, the user can pin that aggregated node by clicking on it, thus removing it from its aggregate parents. A user can select an aggregated node to pin the nodes on the most likely sequence of states and actions, determined by the probabilities of edges between the two. The pinned sequence of the visualization tool 200, starting from the clicked node to the sequence end node, represents a routine variation. Pinned nodes are identified by a (gray) glow effect. All nodes that are part of the extracted routine are automatically pinned, and other nodes are unpinned. Clicking on a pinned node unpins it, which returns the node into the aggregate.

In some implementations, to determine whether or not to pin the node, the user can review the features of individual and aggregate nodes of the visualization tool 200 by hovering over them. In addition to showing the details of individual nodes in the details panel 230, hovering over nodes shows relationships between different elements of the routine. Hovering over any node highlights the most likely routine path from an initial state to the collecting node that includes the hovered over node 210a. This makes it easier to understand the routine states and actions in the area of interest.

The results of the data processing system 100 methods show that the data processing system 100 extracts meaningful patterns of routine behavior. Users were able to point out the patterns that form the high-level routines present in the ground truth for both tasks (RQPat). For the daily routines task, this means that they successfully listed the locations and times of the routines of people in the daily routine data set.

In addition to simply pointing to patterns that represented correct routines, participants also generated some insights for themselves. For example, six participants that were presented with a parent's daily routine that included a child pick up or drop-off specifically pointed out this activity. Also, three participants, that had a case where the parent drops off the child as part of his or her routine, but does not also pick the child up, correctly explained that the other parent was likely responsible for the pickup, without seeing the other parent's routines.

In the driving data set, participants pointed to the patterns that form the main routines (RQPat) and variations in driving behavior (RQVar) of both aggressive and non-aggressive drivers. All participants pointed to patterns that show that aggressive drivers are more likely to drive faster through intersections than non-aggressive drivers. Five participants showed the patterns of routine variations where aggressive drivers are likely to increase their throttle just before entering and leaving intersections. Participants pointed those out as the main differences between the two populations (RQCom). Two participants also pointed to the probabilities of routine variation patterns extracted using our approach that suggest that aggressive drivers are less consistent in their behavior than non-aggressive drivers. Participants likely drew their conclusions from the model, but might also have a preconceived notion that acceleration and speed are correlated with aggressive driving. However, even if our participants had preconceived notions, they could verify and document them using our model.

Through our evaluation, we showed that our models trained using the data processing system 100 and MaxCausalEnt algorithm can extract patterns of routine behavior from demonstrated behavior logs. The ability of MaxCausalEnt algorithm to generalize from small sample sizes enabled it to beat the baseline in the daily routine data set. The performance of the algorithm was comparable with the first-order Markov Model in the aggressive driving data set. This is likely because the training data happened to match the testing data well. However, this is not safe to assume in general case, and MaxCausalEnt's decision-theoretic guarantee that it will not over fit the observed data make it a better choice for modeling routines than the first-order Markov Model.

The visualization tool 200 validated the ability of the data processing system 100 to extract meaningful routines. Participants were able to explore context, actions, and the relationships between the two, to correctly identify the patterns of routines (RQPat) and their variations (RQVar) reported in the previous work. They pointed to these relationships to establish the differences between routines of the two driver populations (RQComp).

The patterns extracted using the data processing system 100 can be used to quickly identify major aspects of routines by visually inspecting them, such as with the visualization tool 200, even after only short amount of training, compared to previous work. For example, Davidoff et al. performed tedious manual labeling of routine and routine variation patterns in the raw data based on feedback from the participants before presenting the patterns on a timeline. Hong et al. used their intuition and expert knowledge of driving behaviors to separately compare the distributions of each sensor stream in the raw data to gain insight about aggressive driving styles. Using the visualization tool 200, users had to only explore the patterns extracted by the data processing system 100.

FIG. 3 shows a simulator 300 interface 310 for the data processing system 100. In some implementations, the interface 310 includes a driving behavior detection and generation tool user interface. A main animation region 320 shows a scenario in which a vehicle 330 travels straight through an intersection. The intersection consists of a main road with 25 miles per hour speed limit and a residential street with stop signs for opposing traffic. The current scenario depicts an automatically detected aggressive driving behavior in vehicle 340 and an automatically generated non-aggressive behavior vehicle 330. Dials 350 show the speed, and gas and brake pedal positions of vehicles 330, 340. The user can select at control 360 a driver and a trip to review. The user can select at control 370 a replay of current driver behavior. The user can select at control 380 and load at control 395 previous and next driving behavior in the current trip. The user can use control 390 to play or replay an automatically generated non-aggressive behavior for the given driving scenario.

The simulator 300 of the data processing system 100 uses an existing routine modeling approach to compute the probability of true labels of variations and deviations in a routine model. The simulator 300 and data processing system 100 apply probability axioms to automatically detect and generate characteristic behaviors for that model. To address manual labeling challenges, the simulator 300 is trained using weakly labeled data, which is an alternative to fully labeled datasets. Weak labels do not necessarily place every instance into the correct class. Instead of labeling each behavior instance individually, the data processing system 100 labels instances at once based on the known routine of the person that exhibited those behaviors. For example, if a driver has had traffic violations due to aggressive driving, the data processing system 100 would label all of the driver's behavior instances as aggressive. The data processing system 100 can train a population model (e.g., for simulator 300) using instances for each unique routine label (e.g., one model for aggressive and one for non-aggressive driving). The data processing system 100 then classifies new instances into one model or the other, given knowledge about the probabilities that each instance will occur. The data processing system 100 uses the same model probabilities to sample (generate) behavior instances.

Since weak labels are by definition noisy, once labels are collected they are processed and improved by the data processing system 100. For example, weak labels are adjusted by the data processing system 100 according to estimated class proportions or distribution of labels in the training set. Such methods try to minimize the difference between the probability distribution of instances in the model and in the training data.

The data processing system 100 uses a recent routine modeling approach that enable detection and generation (e.g., by simulator 300) of behavior instances that are variations of a routine using only weak labels. The data processing system 100 ensures that the probability distribution of routine labels fits the distribution of labels in training data in a principled way. The data processing system 100 does not require prior labels for any behavior instances. The data processing system 100 estimates the probabilities of people being in different situations and the conditional probability of actions they perform in those situations (even for situation and action pairs not present in the training data). Those probabilities enable us to sample and generate behavior instances that belong to a routine.

The data processing system 100 estimates the probability of situations and actions for the simulator 300 using the routine model which is based on the Markov Decision Processes (MDP) framework. Routine models are trained using the principle of Maximum Causal Entropy, which outperforms maximum-likelihood estimators and ensures that the model does not make any more or less assumptions about the causal relationships between situations and actions that make up the behavior instances than what is present in the behavior log data.

The model of the data processing system 100 is a tuple:

[symbol]

=(S,A,P(s′|s,a),Dₛ,P(a|s))

consisting of a set of states S (s ∈ S) representing situations, and actions A (a ∈ A) that a person can take. Each state and action is expressed by feature vectors [symbol] _{S} and [symbol] _{A} that describe the unique states and actions in the model. For example, in a model that captures driving behavior, the state features would describe the road and the vehicle, and the action features would describe how the driver operates the vehicle (e.g., pressing and depressing the pedals).

The probability of the next state after the person performs an action in the current state (P (s′|s, a)) represents how the actions that people perform in different situations affect their environment and vice-versa. The model also includes the expected frequency of states (Dₛ), which estimates how frequently each state occurs in behavior instances in this model. Training a model on behavior instances from only people who have shown evidence of a specific routine model M, allows us to estimate the probability of situations (P(s)) using Ds, and conditional probability of actions given situations (P (a|s)), which estimates how likely the person, with this behavior model, is to perform action a in a state s in that model.

The simulator 300 extends the existing model's ability to support manual behavior classification to enable it to automatically classify behavior instances based on what routine they are a part of. To detect behavior instances that negatively impact people, the simulator 300 shows that they are variations of routines that negatively impact people. To show that a behavior instance could have a positive impact, the simulator 300 shows that it is a variation of a good routine. Because we weakly label behavior instances per-person based on their routines, and not per-instance, we have to ensure that only variations of a given routine model are detected and not variations of another opposite routine.

To classify a behavior instance, the simulator 300 calculates the probability that it belongs to a particular routine. Let b be a behavior instance, and let M be a routine model. The probability that behavior instance b belongs to routine model M is given by P(M|b). Also, we say that behavior instance b does not belong to routine M (i.e., b is a deviation from the routine) if for some level 0<a<1:

P(M|b)<a

Then, behavior instance b is more likely to belong to routine model M than some other routine model M′, if:

P(M′|b)<P(M|b)

Given two routine models M and M′ (e.g., one that negatively impacts people and the other that impacts them positively), behavior instance is in routine M, but not in routine M′, if for some level 0<a<1:

P(M′|b)<a≦P(M|b)

Intuitively, Equation 4 means that, if there is evidence that b is a deviation from M′, but no evidence that it is also a deviation from M, then b is classified as M. Thus, a represents the probability that a behavior instance is a deviation. Increasing the value of a increases our chance of false positives (classifying b as M, when it is not a variation of M), while decreasing a increases the chances of false negatives (not classifying b as M, when b is a variation of M). Note that Equation 4 implies that Equation 3 also holds.

To classify the behavior instances requires an indicator function that, given a behavior instance b, results in 1 when the instance is in routine M, and 0 when it is not. The data processing system 100 defines the following indicator function as a classifier:

h(b)=I(P(M′|b)<a)·I(a≦P(M|b))

The existing supervised machine learning algorithms would require per-instance labels to calculate P (M|b) for each routine. The data processing system 100 instead calculates the probability that behavior instance b belongs to routine Musing Bayes rule:

$$P ( M \vert b ) = \frac{P ( b \vert M ) \cdot P ( M )}{P ( b )}$$

where P (M|b) is the probability of the instance given that it belongs to the routine M, P(M) is the probability that the routine of the person whose behavior we are classifying is M, and P (b) is the probability that people, regardless of their routine, would perform behavior instance b.

Assuming two models of opposing routines M and M′ with probabilities of possible behavior instances in the model, by law of total probability, Equation 6 becomes:

$$P ( M \vert b ) = \frac{P ( b \vert M ) \cdot P ( M )}{P ( b \vert M ) \cdot P ( M ) + P ( b \vert {M}^{′} ) \cdot P ( {M}^{′} )}$$

The behavior instance b is a finite, ordered sequence of situations and actions (s₁, a₁, s₁, a₁, . . . , sₙ, aₙ), where in each situation s in the sequence, the person performs action a₁ which results in a new situation s₁₊₂. Then, assuming that each situation depends only on the previous situation and action, the data processing system 100 calculates the probability of the behavior instance using:

$$P ( b \vert M ) = {\prod }_{i} p ( {s}_{i} ) \cdot p ( {a}_{i} \vert {s}_{i} ) \cdot p ( {s}_{i + 1} \vert {s}_{i} , {a}_{i} ) \qquad ( 6 )$$

where the probability of the initial situation s₀(p(s₀)) and the conditional probability of actions given situations (p(a₁|s₁)) are specific to routine model M.

The data processing system 100 can automatically generate behavior instances that are variations of a routine. Having an MDP model enables the data processing system 100 to find the sequence of situations and actions that maximizes expected reward based on a reward function, which is the most probable behavior instance starting from a given situation. However, generating only the most probable instances hides the inherent uncertainty and variance in human behavior.

The data processing system 100 samples behavior instances using the probability distributions in a routine model. The data processing system 100 samples an initial situation so from the probability distribution of situations P(s). The data processing system 100 samples the next action from the probability distribution of actions given situation s₀(P(a|s₀)), which gives us an action a₀. The data processing system 100 samples the next situation in the sequence using transition probabilities P(s|s₀, a₀) and get a situation s₁. The data processing system 100 repeats this process for situation Si and so on until the data processing system 100 encounters a stopping situation or reaches a maximum behavior instance length.

The data processing system 100 samples from a subset of initial situations constrained on the values of the features of those situations (P (s|fₛ)). For example, for driving, the data processing system 100 can sample situations when a driver is approaching a four-stop intersection. This conditional probability distribution can easily be computed from situation frequencies (Dₛ) from a routine model. This allows the simulator 300 to generate behavior instances characteristic of a routine for specific situations.

The simulator 300 illustrates the model of the data processing system 100 using a real-life use case in the driving domain. Poor driving routines negatively impact people. Drivers who routinely engage in aggressive driving behaviors present a hazard to other people in traffic. The ability to automatically detect aggressive driving instances enables technology to help drivers improve. For example, a system could try to calm the driver to avoid immediate future aggressive behaviors. It could wait until after the trip is over and show the driver a better, non-aggressive way to drive on the same portion of the trip where the driver drove aggressively. If the driver continues to drive aggressively, the system could suggest that the driver take corrective driving classes with a list of particular instances to work on.

Labeling driving behavior instances is difficult because drivers may be prone to aggressive driving behavior in some situations, but not in others (e.g., rushing yellow lights during rush hour. High-level characteristics of aggressive routines (e.g., speeding) can be detected with lengthy manual observations. However, high-level observations may not capture nuances of driving behaviors required to label driving instances to train classification algorithms. Thus, the data processing system 100 detects and generates (e.g., using the simulator 300) aggressive and non-aggressive driving behavior using weakly labeled data.

In one example, the data processing system 100 uses the dataset used in and originally collected by Hong et al. Banovic et al. showed that this data can be used to train meaningful driving routine models of how non-aggressive and aggressive drivers drive through intersections. The data was collected from 26 licensed drivers (13 male and 13 female; ages between 21 and 34) as they drove daily through a mid-sized city in North America. The data collection lasted 3 weeks and resulted in a total of 542 hours of driving data from 1,017 trips. The data we use was collected using an On-board Diagnostic tool (OBD2), and was recorded every 500 milliseconds.

In this example, the data processing system 100 extends the original data set and the way driving behaviors were modeled. We use the Open Street Map API to mark each intersection in the data with speed limits, intersection types (e.g., t-intersection), and traffic signs and signals. This allows the data processing system 100 to detect more nuanced behaviors than those in Hong and Banovic. For example, with this addition the data processing system 100 can detect if a driver has properly stopped at a stop sign or not, whereas in the old dataset this was not possible.

TABLE 5
Situation features capturing the different contexts the driver can be in.

| | |
|---|---|
| Feature | Description |

Goals

| | |
|---|---|
| Maneuver | The type of maneuver at the intersection |
| | {STRAIGHT, RIGHT TURN, LEFT TURN} |

Environment

| | |
|---|---|
| Position | Current position of the vehicle in the intersection |
| | {APPROACHING, ENTERING, EXITING, AFTER} |
| Rush hour | Whether the trip is during rush hour or not |
| | {TRUE, FALSE} |
| Intersection | Intersection layout including road types in each direction |
| | (40 discrete values) |
| Traffic signs | Traffic signal layout |
| | {STOP, STOP OPPOSITE, ALL STOP, LIGHT SIGNAL} |
| Maximum | The maximum speed in each position of the intersection. |
| Speed | {25, 35, 45} |

Vehicle

| | |
|---|---|
| Speed | Current vehicle speed (5-bin discretized + stopped) |
| Throttle | Current throttle position (3-bin discretized) |
| Acceleration | Current positive/negative acceleration (5-bin discretized) |

TABLE 6
Action features representing actions that drivers can
perform between stages of the intersection.

| Feature | Description |
|---|---|
| Pedal | Aggregated gas and brake pedal operation between |
| | intersection positions (47 discrete values) |

Lack of information about other vehicles that may have impacted the driver's behavior remains a limitation.

The data processing system 100 divides intersections into four stages (approaching, entering, exiting, and leaving the intersection). Sequences of these stages are the behavior instances in this model. Position information, along with the type of maneuver and details of the vehicle, such as its current speed, make up the situation features (Table 1). Actions in this model represent how the driver operates the vehicle by depressing the gas (throttle) and brake pedals. Because the data processing system 100 models driving through an intersection in stages, the data processing system 100 aggregates the driver's actions between different intersection stages to represent the changes in throttle and braking levels (Table 4).

The data processing system 100 weakly labels instances into aggressive and non-aggressive routines, which were assigned based on drivers' self-reported driving violations and their answers to the driver behavior questionnaire. The data processing system 100 builds two models, one for each label, and estimates the probabilities of possible behavior instances in each model. To model how a vehicle moves in response to driver actions, the data processing system 100 empirically estimated the state-action transitions (P (s′|s, a)) from the training data by counting the frequency of transitions between features that describe the vehicle state. The data processing system 100 identified 20,312 different states and 43 different actions in the dataset. The final model consisted of 234,967 different states and 47 different actions, with 5,371,338 possible transitions.

The model trained on behavior instances of aggressive drivers in the training data allows the data processing system 100 to compute the probability of situations (P(s|A gg)) and probability of actions given situations (P(a|s,Agg)). Similarly, the other model, trained on non-aggressive drivers, allows the data processing system 100 to compute P(s|NonAgg) and P(a|s₁NonAgg).

To classify a new behavior instance b as either aggressive or not, the data processing system 100 uses an indicator function which is 1 when b is a variation of the aggressive routine, and 0 otherwise:

h(b)=I(P(NonAgg|b)<a)·I(a≦P(Agg|b))

Given the two classifiers and two different a (one for each classifier), the data processing system 100 can classify behavior instances as strictly aggressive, strictly non-aggressive, or neither. Later in our validation section, the data processing system 100 uses different values for a to test the impact of this parameter on our classification. We estimate the prior probability of an aggressive driver P(Agg)=0.5 because the number of behavior instances in the training set is balanced between people with the two driving routines.

The data processing system 100 samples driving behavior instances from the driving routine models by conditioning initial situations (a driver approaching an intersection) on features that describe the environment and driver goals (see Table 3). The data processing system 100 samples the initial situation from the conditional probability distribution P(s|fₛ), where fₛ is a set of situation features values. Conditioning the probability of the initial situation on features that include the state of the vehicle (e.g., speed) also allows the data processing system 100 to explore how a non-aggressive driver would recover from a particular aggressive situation.

Generating behavior instances for specific driving situations allows the data processing system 100 to explore “what-if” scenarios for the two driver populations, even if the training data does not include those exact scenarios. For example, suppose that the data processing system 100 detects that a driver aggressively approached a t-intersection with traffic lights. To learn how a non-aggressive driver would behave in that scenario, the data processing system 100 samples behaviors from the non-aggressive model starting with an initial situation in the same intersection. The data processing system 100 uses the generated non-aggressive instance to show the driver how to improve.

Validating these algorithms is hard because they are trained with no ground truth about which instances are aggressive and which are non-aggressive. “Leave-one-out” validation was used to avoid training and testing on the same data, and manually checked if a subset of detected/generated instances were variations of the two models. To review the variations, the simulator 300 animated replays of both drivers' recorded and the generated behaviors. Visualizing behaviors enables verification that the algorithms performed correctly and faster than with manual behavior log analysis. It also allowed driving instructors (experts) who were not familiar with data analysis techniques to verify these findings.

In some implementations, the driving behavior simulator 300 can be implemented for commercial devices, such as Android touchscreen tablets. The simulator 300 can be a client mobile application that is powered by a server side routine modeling service. For example, the client downloads driving behavior instances from the server and plays them to the user.

Returning to FIG. 3, a client user interface of the simulator 300 features an animation area 310, which depicts a vehicle 330 in an intersection reminiscent of illustrations found in driving study books. Each intersection depicts a situation with an intersection type (four-way intersection or t-intersection), intersecting road types (main roads or residential roads), and traffic signs (speed limits, stop signs, and traffic lights). The data shows that the intersection is controlled by traffic lights. The roads and the vehicle depict average road and sedan vehicle sizes in North America.

Vehicle animation of the simulator 300 shows how an actual vehicle may move through an intersection. A 2D physics engine is used by the simulator 300 to compute the speed and acceleration of the vehicle as it drives through different intersection positions. A maneuver feature guides the trajectory of the vehicle. An action pedal feature modifies speed in between two consecutive positions in the intersection to illustrate how drivers' actions affect the movement of the vehicle 330.

A user can review trips from a particular driver using control 360, and load intersections from a trip or a subset of intersections where the driver drove either aggressively or non-aggressively. The user can then replay the current driver's behavior instance using control 370, or switch between previous and next behavior instances in the subset, such as with controls 380 and 395. For any instances, the user can generate and simulate with an animation how a non-aggressive driver would drive through the same intersection, such as with control 390.

The simulator 300 shows driving maneuvers in abstracted intersections. To ensure that general users can interpret the animations correctly, a pilot study was conducted with 12 participants (6 male and 6 female), who were ages between 19 and 35 (median=21), and had between 0 and 13 years of driving experience (median=3).

Participants arrived at our lab and signed a consent form before we briefed them about the study. They reviewed 25 randomly selected driving behaviors from our training set, and compared them with randomly generated behaviors from our model. For each actual and generated instance, we asked them to write a paragraph describing what the driver did in the intersection, and another paragraph about what the driver did differently between the two. The first five scenarios were warm ups to ensure the task was understood.

TABLE 7
The mean percentage of behavior instances classified as aggressive,
non-aggressive, or neither across different α levels.

| | α = 0.1 | | | α = 0.25 | | | α = 0.45 | | | α = 0.5 | | |
|---|---|---|---|---|---|---|---|---|---|---|---|---|
| | gg | either | onagg | gg | either | onagg | gg | either | onagg | gg | either | onagg |
| aggressive | % | 9.99% | .01% | .02% | 2.34% | .64% | 1.82% | 6.25% | 1.92% | 6.23% | % | 3.77% |
| non- | % | 9.77% | .23% | .08% | 1.91% | .01% | 8.45% | 3.78% | 7.76% | 0.35% | % | 9.65% |
| aggressive | | | | | | | | | | | | |

Two researchers independently coded participant responses and rated them as: 1) incorrect, if the answer did not match the driving behavior in the scenario; 2) partially correct, if the answer had most, but not all relevant information about the scenario; and 3) correct; if the answer had relevant information about the scenario and the driving behavior without mistakes. Each researcher rated 600 descriptions and they perfectly agreed on 83.86% of them (Cohen's kappa=0.54). For each rating, the average score was computed and rounded down towards the lower of the two scores.

The participants accurately described the scenarios. They correctly described 85% of driving instances, partially correctly described 13%, and incorrectly described 2% of the instances. They correctly compared 79% of instances, partially compared 15.5%, and incorrectly compared 5.5% driving instances. To increase the users' accuracy and to reduce the time and effort to compare behaviors, the simulator 300 was modified to show a ghost vehicle 340 when the user (re)played generated behaviors.

The simulator 300 can be used to manually inspect behavior instances that are detected using the data processing system 100. For each driver in the dataset, the data from that driver was withheld, and the data processing system 100 trained the models on the remaining drivers. The driver data withheld was used by the data processing system 100 to classify driving behavior instances from that driver using the two indicator functions (Equations 9 & 10). The data processing system 100 sorted classified behavior instances by their frequency in the data and the probability that they belong to one of the routine models, and inspected the most frequent behavior instances.

The results show that the data processing system 100 on average found more aggressive driving instances among the aggressive drivers and more non-aggressive instances for the non-aggressive drivers across a levels. Table 7 shows mean percentages of classified behavior instances for different a levels.

In a majority of detected aggressive instances, the drivers drove over the speed limit. In the most aggressive instances, drivers were exceeding the speed limit by 20 MPH. In most of these situations, the drivers were going straight through intersections with stops signs for traffic coming from the left or right. The drivers were likely expecting other drivers to respect their signs. However, at high speeds they may not be able to react in time if a vehicle turns in front of them.

The majority of actions in the detected aggressive behavior instances involved drivers pressing hard on gas and brakes. Aggressive driving instances also included pressing the pedals softly. Further analysis showed that the drivers were already in situations that were indicative of aggressive driving when they performed those actions. Although the drivers had made an attempt to correct their behavior, it was already too late.

Drivers in automatically detected by the data processing system 100 in non-aggressive behaviors observed the traffic law (e.g., maintained the speed limit). The most likely non-aggressive instances included an easily identifiable pattern where the driver would brake softly when approaching an intersection and then applying gas softly to increase the speed to clear the intersection. Non-aggressive driving instances were equally likely to occur in and out of rush hour. This is in contrast with about 70% of aggressive driving instances that occurred during rush hour.

The data processing system 100 detected nuanced differences between the aggressive and non-aggressive instances. For example, the data processing system 100 detected a common driving behavior instance where the driver goes through an intersection with traffic lights at a constant speed matching the speed limit of 35 MPH as aggressive with high probability (p_{Agg}=0.6892). A generated non-aggressive behavior for the same scenario shows that non-aggressive drivers are likely to slow down slightly as they approach the intersection and then increase their speed after clearing the intersection (P_{NonAgg}=0.7458). This shows that the data processing system 100 can detect behaviors that may not be obvious, but that are characteristic of a particular routine.

Two licensed driving instructors volunteered to evaluate the data processing system 100 and ensure that they accurately detect and generate meaningful driving behaviors. The evaluation consisted of two tasks. The instructors first each rated 55 different randomly selected driving behavior instances from our training data set. Instructors rated each instance as: 1) aggressive, 2) non-aggressive, or 3) neither. The instructors then rated another 30 random automatically detected aggressive driving instances and 30 corresponding generated non-aggressive instances. They also rated if each generated instance was a good non-aggressive alternative to the aggressive behavior or not. In both tasks, the first 5 behavior instances were used as warm up and to explain the tasks to the instructors. The probabilities that behavior instances belong to the aggressive routine model (P_{Agg}) between different ratings were compared using the Kruskal-Wallis test. A pairwise comparison using Mann-Whitney's U test with Bonferroni correction.

Differences in P_{Agg} were found between different instructor ratings (χ²(2)=6.73, p=0.0346). The median P_{Agg}=62.40% of instances rated as aggressive was higher than P_{Agg} of behavior instances rated as non-aggressive (median=48.14%; p=0.0360, r=0.31). The difference between P_{Agg} of instances rated aggressive and instances rated as neither (median=50.69%) was only marginally statistically significant (p=0.0940, r=0.34). The tests did not find a statistically significant difference between P_{Agg} of instances rated as non-aggressive and neither (p>0.9999, r=0.02).

Over 75% of instances rated as aggressive had P_{Agg} greater than 50.32%. Over 75% of instances rated as neither and non-aggressive had P_{Agg} lower than 59.75% and 57.28% respectively. To detect as many aggressive instances, while limiting false positives, an aggressive classifier a_{AGG} was set to 1−0.55=0.45. Because more than 75% of instances rated as neither had P_{Agg} greater than 38.98%, a more cautious non-aggressive instance classifier a_{NonAGG} was set to 0.35.

The instructors rated 72.5% of automatically detected aggressive instances as aggressive, 5% as non-aggressive, and 22.5% as neither in the second task. They rated 85% of the corresponding automatically generated non-aggressive instances as non-aggressive, 5% as aggressive, and 10% as neither. They confirmed that the generated instances that they rated as non-aggressive were appropriate alternatives for the automatically detected aggressive instances.

The classifier detected aggressive driving instances that match known characteristics of aggressive driving behavior, hard acceleration and braking. The two driving instructors also confirmed that in most cases the data processing system 100 detected and generated non-aggressive driving behavior instances that are safe enough to suggest to drivers as alternatives to aggressive driving behaviors. However, in some cases, the instructors could not properly rate the instances due to the lack of information about the environment (e.g., other vehicles in traffic, pedestrians).

The validation also yielded some surprising findings. For example, drivers labeled as non-aggressive may still frequently engage in aggressive behaviors. Thus, high-level classification techniques that target aggressive drivers (e.g., driving assessment questionnaires) may miss important behaviors that could help other people improve their driving, too. This also means that sampling from the non-aggressive driving model may in some cases result in an aggressive behavior instance. To ensure that the data processing system 100 never suggests aggressive driving behavior to the user, only generated instances that are classified as characteristic of a non-aggressive driving routine are presented.

The data processing system 100 detection algorithm is able to point to new information about what is characteristic of aggressive driving. This does not mean that driving instances detected as characteristic of aggressive routine are necessarily endangering the driver and others in traffic. It means that drivers that do exhibit such behaviors may be at higher risk of causing intentional traffic violations because they routinely engage in aggressive driving behaviors.

The data processing system 100 simulator 300 can generate behaviors from both aggressive and non-aggressive models to help drivers understand how these routines differ in frequent driving situations. However, the data processing system 100 is uniquely positioned to detect actual drivers' aggressive behaviors to help them reflect on differences between their behavior and generated non-aggressive driving behavior in the same situations.

The data processing system 100 extends an existing routine modeling approach to automatically detect and generate behaviors using probabilities that people with a certain routine will perform sequences of actions in a given situation. The data processing system 100 calculates the probabilities in a principled way that ensures that the model best fit training data from large behavior logs.

The challenge of labeling individual behavior instances is not limited to driving and spans number of other domains. For example, the data processing system 100 can simplify labeling daily routines of parents who are likely to forget to pick up their children. Here, the weak, per-parent labels indicate if they have forgotten their children in the past or not. The data processing system 100 offers a generalizable solution to classify and generate behavior instances in different domains, because it is based on probability axioms and a proven model of routine behavior.

The data processing system 100 can automatically detect and generate driving behavior instances using weakly labeled data. The data processing system 100 can detect behavior instances that can negatively impact people and those that can have a positive impact on them. An important by-product of our approach is that it can also be used to detect behavior instances that are not characteristic of any particular routine (e.g., behavior instances that are frequently exhibited by both aggressive and non-aggressive drivers). Such behavior instances are called aproblematic, and hypothesize that behavior change technologies could use such instances as a stepping stone towards better behavior.

In addition to determining whether a driver is acting aggressive, the data processing system 100 can be used to identify other routines in order to determine behavior in users that is representative of a condition of the user. A source (e.g., person) may exhibit one or more common symptoms or behaviors that are representative of a class of behavior. In some implementations, the data processing system 100 can detect a routine that is indicative of drug addition, such as opioid cravings. For example, the source might ask certain questions, give certain answers, and so forth which typically indicate an addition to a substance. In some implementations, the data processing system 100 can detect routines of sources that indicate that the source is likely to be readmitted to a hospital. For example, a user may exhibit particular symptoms in response to receiving a treatment while at a hospital. The user's response to the symptoms may indicate that another hospital visit is likely. For example, the data processing system 100 may classify the treatment as “successful” or “unsuccessful.” Characteristics of these behaviors can be learned, such as by a neural network, and classified using a feature vector, to identify states and actions associated with the class of behavior that form a routine or variation.

FIG. 4 is a block diagram showing examples of components of networked system 400. Client device 410 can be any sort of computing device capable of taking input from a user and communicating over network 420 with data processing system 100 and/or with other client devices. Client device 410 can be a mobile device, a desktop computer, a laptop, a cell phone, a personal data assistant (“PDA”), a server, an embedded computing system, a mobile device and so forth, and can run the simulator 300 interface and visualization 200 interface.

Data processing system 100 can be a variety of computing devices capable of receiving data and running one or more services. In an example, data processing system 100 can include a server, a distributed computing system, a desktop computer, a laptop, a cell phone, a rack-mounted server, and the like. Data processing system 100 can be a single server or a group of servers that are at a same position or at different positions (i.e., locations). System and client device 410 can run programs having a client-server relationship to each other. Although distinct modules are shown in the figures, in some examples, client and server programs can run on the same device.

Data processing system 100 can receive data from wireless devices 430 and/or client device 410 through input/output (I/O) interface 440. I/O interface 440 can be a type of interface capable of receiving data over a network, including, e.g., an Ethernet interface, a wireless networking interface, a fiber-optic networking interface, a modem, and so forth. System 430 also includes a processing device 460 and memory 450. A bus system 470, including, for example, a data bus and a motherboard, can be used to establish and to control data communication between the components of data processing system 100.

Processing device 460 can include one or more microprocessors. Generally, processing device 460 can include an appropriate processor and/or logic that is capable of receiving and storing data, and of communicating over a network (not shown). Memory 450 can include a hard drive and a random access memory storage device, including, e.g., a dynamic random access memory, or other types of non-transitory machine-readable storage devices. Memory 450 stores computer programs, such as the visualization engine 200, that are executable by processing device 460. These computer programs include a simulator 300 for implementing the operations and/or the techniques described herein. The simulator 300 can be implemented in software running on a computer device, hardware or a combination of software and hardware. A data repository 480 can store data, such as behavior logs, etc.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible program carrier for execution by, or to control the operation of, a processing device. Alternatively, or in addition, the program instructions can be encoded on a propagated signal that is an artificially generated signal, e.g., a machine-generated electrical, optical, or electromagnetic signal that is generated to encode information for transmission to suitable receiver apparatus for execution by a processing device. A machine-readable medium can be a machine-readable storage device, a machine-readable storage substrate, a random or serial access memory device, or a combination of one or more of them.

The term “processing device” encompasses apparatuses, devices, and machines for processing information, including by way of example a programmable processor, a computer, or multiple processors or computers. The apparatus can include special purpose logic circuitry, e.g., an FPGA (field programmable gate array) or an ASIC (application-specific integrated circuit) or RISC (reduced instruction set circuit). The apparatus can also include, in addition to hardware, code that creates an execution environment for the computer program in question, e.g., code that constitutes processor firmware, a protocol stack, an information base management system, an operating system, or a combination of one or more of them.

A computer program (which may also be referred to as a program, software, a software application, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or information (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input information and generating output. The processes and logic flows can also be performed by, and apparatus can also be implemented as, special purpose logic circuitry, e.g., an FPGA (field programmable gate array) or an ASIC (application-specific integrated circuit) or RISC.

Computers suitable for the execution of a computer program include, by way of example, general or special purpose microprocessors or both, or any other kind of central processing unit. Generally, a central processing unit will receive instructions and information from a read-only memory or a random access memory or both. The essential elements of a computer are a central processing unit for performing or executing instructions and one or more memory devices for storing instructions and information. Generally, a computer will also include, or be operatively coupled to receive information from or transfer information to, or both, one or more mass storage devices for storing information, e.g., magnetic, magneto-optical disks, or optical disks. However, a computer need not have such devices. Moreover, a computer can be embedded in another device, e.g., a mobile telephone, a smartphone or a tablet, a touchscreen device or surface, a personal digital assistant (PDA), a mobile audio or video player, a game console, a Global Positioning System (GPS) receiver, or a portable storage device (e.g., a universal serial bus (USB) flash drive), to name just a few.

Computer-readable media suitable for storing computer program instructions and information include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and (Blue Ray) DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as an information server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital information communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In another example, the server can be in the cloud via cloud computing services.

While this specification includes many specific implementation details, these should not be construed as limitations on the scope of any of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A data processing system for structuring data, the data processing system comprising:
a repository storing data referencing one or more sources, the data representing actions and states for each of the one or more sources;
a data structuring engine that generates a data sequence, for each source, from one or more portions of the stored data for that source, each data sequence representing one or more states and one or more actions for the source;
an aggregation engine that aggregates data sequences for the one or more sources into a data structure, each entry of the data structure representing a state, each entry comprising:
an identifier for the state;
a probability value of at least one action occurring at the state, the probability value based on a proportion of the data sequences, comprising the state, that also comprise the at least one action; and
frequency data indicating a proportion of the data sequences included in the entry; and
a classification engine that traverses the data structure and classifies the data sequences into groups based on probability values and frequency data associated with each state of each respective data sequence.

2. The data processing system of claim 1, wherein the classification engine identifies a first data sequence of a group of data sequences to be a particular sequence, and a second data sequence of the group to be a variation of the particular sequence, the variation comprising at least one particular action for a data sequence having a probability value above a predetermined threshold.

3. The data processing system of claim 1, further comprising a simulation engine for generating, using the data structure, a simulation comprising:
an environment having one or more objects; and
one or more data sequences automatically generated by the simulation engine, each data sequence of the one or more data sequences representing behavior of an object of the one or more objects of the environment, the one or more data sequences being automatically generated by:
selecting, from the data structure generated, a group of the data sequences classified by the classification engine;
retrieving, from the data structure generated, probability values associated with states of the data sequences of the group;
retrieving, from the data structure generated, frequency data associated with the states of the data sequences of the group; and
generating a data sequence that simulates a new source by traversing the data structure according to the probability values and the frequency data;
wherein the one or more objects behave in the simulation according to the generated data sequence representing the behavior of the object.

4. The data processing system of claim 3, wherein the simulation further comprises:
an interface comprising one or more controls for controlling behavior of an additional object and a display for the environment of the simulation; and
a logging engine that records the behavior of the additional object;
wherein the data structuring engine generates an additional data sequence for the additional object according to the behavior of the additional object recorded by the logging engine; and
wherein the classification engine classifies the additional data sequence into one of the groups.

5. The data processing system of claim 4, wherein the aggregation engine updates the probability values and the frequency data based on the additional data sequence.

6. The data processing system of claim 1, wherein each state comprises a feature vector representing one or more characteristics of the state.

7. The data processing system of claim 1, wherein each state is associated with a utility score based on one or more probability values and frequency data associated with the state.

8. The data processing system of claim 1, further comprising a visualization engine that generates a visual representation of a group of data sequences, wherein the visual representation comprises:
an indicator for each of the states and actions of the data sequences of the group;
a representation of each probability value; and
an indication of a particular data sequence of the group.

9. The data processing system of claim 8, wherein the visual representation comprises one or more selectable controls for selecting a data sequence of the group.

10. The data processing system of claim 9, wherein the visual representation provides a visual indication of a variation of the selected data sequence, the variation comprising at least one particular action for a data sequence based on a probability value of the particular action.

11. The data processing system of claim 1, wherein the data structuring engine extracts the actions and the states from the data referencing one or more sources by identifying one or more features of the data that correspond to a state or an action.

12. The data processing system of claim 1, wherein the data representing one or more sources comprises behavior logs.

13. A data processing system for generating a visualization, the visualization comprising:
a first display comprising:
a first data sequence of a data structure, the first data sequence representing first states and first actions, wherein the first states and the first actions are ordered and each displayed proximate to respective one or more representations of one or more feature vectors that define the first states and the first actions;
one or more second data sequences, the one or more second data sequences representing second states and second actions that are less likely to occur relative to occurrences of the first states and the first actions of the first data sequence; and
one or more connectors that connect the first states and the first actions to one another and to the second states and the second actions, wherein a thickness a connector represents a probability value;
wherein each of the first states, the first actions, the second states and the second actions comprise a selectable control that enable the first display to show additional states and additional actions when the selectable control is activated, and
wherein each of the first states, the first actions, the second states, and the second actions each comprise a passive control, wherein the passive control enables the first display to show additional details about a respective state or action when the passive control is activated; and
a second display rendering a visual representation of the data structure.

14. A method for structuring data, the method comprising:
storing data referencing one or more sources, the data representing actions and states for each of the one or more sources;
generating a data sequence, for each source, from one or more portions of the stored data for that source, each data sequence representing one or more states and one or more actions for the source;
aggregating data sequences for the one or more sources into a data structure, each entry of the data structure representing a state, each entry comprising:
an identifier for the state;
a probability value of at least one action occurring at the state, the probability value based on a proportion of the data sequences, comprising the state, that also comprise the at least one action; and
frequency data indicating a proportion of the data sequences included in the entry; and
traversing the data structure to classify the data sequences into groups based on probability values and frequency data associated with each state of each respective data sequence.

15. The method of claim 14, further comprising:
identifying a first data sequence of a group of data sequences to be a particular sequence, and a second data sequence of the group to be a variation of the particular sequence, the variation comprising at least one particular action for a data sequence having a probability value above a predetermined threshold.

16. The method of claim 14, further comprising:
simulating an environment having one or more objects; and
automatically generating one or more data sequences, each data sequence of the one or more data sequences representing behavior of an object of the one or more objects of the environment, the one or more data sequences being automatically generated by:
selecting, from the data structure generated, a group of the data sequences classified;
retrieving, from the data structure generated, probability values associated with states of the data sequences of the group;
retrieving, from the data structure generated, frequency data associated with the states of the data sequences of the group; and
generating a data sequence that simulates a new source by traversing the data structure according to the probability values and the frequency data;
wherein the one or more objects behave in the simulation according to the generated data sequence representing the behavior of the object.

17. The method of claim 16, further comprising:
receiving commands from an interface comprising one or more controls for controlling behavior of an additional object;
displaying the behavior of the additional object;
recording the behavior of the additional object;
generating an additional data sequence for the additional object according to the behavior of the additional object; and
classifying the additional data sequence into one of the groups.

18. The method of claim 17, further comprising updating the probability values and the frequency data based on the additional data sequence.

19. The method of claim 14, wherein each state comprises a feature vector representing one or more characteristics of the state.

20. The method of claim 14, wherein each state is associated with a utility score based on one or more probability values and frequency data associated with the state.

21. The method of claim 14, further comprising:
generating a visual representation of a group of data sequences, wherein the visual representation comprises:
an indicator for each of the states and actions of the data sequences of the group;
a representation of each probability value; and
an indication of a particular data sequence of the group.

22. The method of claim 21, wherein the visual representation comprises one or more selectable controls for selecting a data sequence of the group.

23. The method of claim 22, wherein the visual representation provides a visual indication of a variation of the selected data sequence, the variation comprising at least one particular action for a data sequence based on a probability value of the particular action.

24. A non-transitory computer readable medium storing instructions that are executable by one or more processors configured to perform operations comprising:
storing data referencing one or more sources, the data representing actions and states for each of the one or more sources;
generating a data sequence, for each source, from one or more portions of the stored data for that source, each data sequence representing one or more states and one or more actions for the source;
aggregating data sequences for the one or more sources into a data structure, each entry of the data structure representing a state, each entry comprising:
an identifier for the state;
a probability value of at least one action occurring at the state, the probability value based on a proportion of the data sequences, comprising the state, that also comprise the at least one action; and
frequency data indicating a proportion of the data sequences included in the entry; and
traversing the data structure to classify the data sequences into groups based on probability values and frequency data associated with each state of each respective data sequence.
